(19) United States
(12) Patent Application Publication
(10) Pub. No.: US 2007/0154700 A1
(43) Pub. Date: Jul. 5, 2007

(54) Tunable heat regulating textile

(76) Inventor: Igor Victorovich Touzov, Cary, NC (US)

Correspondence Address: IGOR V TOUZOV, 212 CRESTONE DRIVE, CARY, NC, 27513, US

(21) Appl. No.: 11/308,107

(22) Filed: Mar. 7, 2006

Related U.S. Application Data
(63) Continuation-in-part of application No. 11/306,529, filed on Dec. 30, 2005.
(63) Continuation-in-part of application No. 11/306,530, filed on Dec. 30, 2005.
(63) Continuation-in-part of application No. 11/307,051, filed on Jan. 20, 2006.
(63) Continuation-in-part of application No. 11/307,125, filed on Jan. 24, 2006.
(63) Continuation-in-part of application No. 11/307,292, filed on Jan. 31, 2006.
(63) Continuation-in-part of application No. 11/307,359, filed on Feb. 2, 2006.
(63) Continuation-in-part of application No. 11/306,527, filed on Dec. 30, 2005.

(51) Int. Cl. B32B 3/26

(52) U.S. Cl. 428/304.4

(57) ABSTRACT

Textile material dynamically changes its characteristics from thermal insulator to high performance heat conductor and spreader.

### RELATED APPLICATIONS

This application is a continuation-in-part of each of:
(1) U.S. patent application Ser. No. 11/307359, filed Feb. 2, 2006, entitled “Stretchable and transformable planar heat pipe for apparel and footwear, and production method thereof”, hereby incorporated by reference
(2) U.S. patent application Ser. No. 11/307,292, filed Jan. 31, 2006, entitled “High throughput technology for heat pipe production”, hereby incorporated by reference
(3) U.S. patent application Ser. No. 11/307,125, filed Jan. 24, 2006, entitled “Integral fastener heat pipe”, hereby incorporated by reference
(4) U.S. patent application Ser. No. 11/307,051, filed Jan. 20, 2006, entitled “Process of manufacturing of spongy heat pipes”, hereby incorporated by reference
(5) U.S. patent application Ser. No. 11/306,530, filed Dec. 30, 2005, entitled “Heat pipes utilizing load bearing wicks”, hereby incorporated by reference
(6) U.S. patent application Ser. No. 11/306,529, filed Dec. 30, 2005, entitled “Perforated heat pipes”, hereby incorporated by reference
(7) U.S. patent application Ser. No. 11/306,527, filed Dec. 30, 2005, entitled “Heat pipes with self assembled compositions”, hereby incorporated by reference

### FIELD OF THE INVENTION

Present invention relates to advanced textile and fabrics suitable for technical or apparel and footwear applications. In particular, materials for heat and cold protection and medical aids directly relates to the field of this invention.

### BACKGROUND OF THE INVENTION

Traditional thermal management solutions in textile and fabric have evolved from wool and down to Polartec®, CoolMax®, and phase changing materials. Although efficient in many aspects, these materials fail to adapt to ever-changing conditions of human body. As an example, while providing adequate performance to physically active body, they give no protection to inactive person with slower blood circulation.

Phase changing designs such as one invented by Buckley (U.S. Pat. No. 6,004,662) do not provide long-lasting effect because energetic capacity of the materials is limited by amount of phase changing component.

On other hand, integration of special hardware elements such as tubes, wires, etc. into apparel design reduces comfort and increases cost of wearable articles.

### SUMMARY OF THE INVENTION

This invention utilizes concept of textile material 1 having phase changing liquid refrigerant 2 disposed within volume 3 of tows, or threads, or film, or any other topological arrangement comprising the structure of material 1. Liquid 2 remains at balance with vapors 4 of constituent chemicals. Additional gaseous elements 5 are added into the vapor mix. Elements 5 have lower boiling point than lowest intended usable temperature of material 1.

Shell material 6 insulates volume 3 from ambient air. Composition of shell 6 is selected to sustain chemicals 2 and 5 and prevent escape of their vapors. On other hand shell 6 may be permeable or partially permeable to other chemicals (i.e. air components).

Additional structural element 7 may be introduced into design of articles utilizing material 1. Element 7 adjusts pressure inside volume 3. This adjustment can be achieved by applying mechanical deformation on specific areas of material 1, or by increasing partial content of chemicals 5.

### DETAILED DESCRIPTION OF THE INVENTION

Preferred embodiment of the invention utilizes simple weave fabric mesh composed of hollow threads 8 described in co-pending U.S. patent application Ser. No. 11/306,530. Material of threads 8 is Nylon. Thin Nylon film forms shell 6 that seals inner volume of threads 8.

Walls of threads 8 are saturated with decafluorobutane acting as refrigerant 2. Ammonia is used as gaseous element 5. Pressure inside volume 3 is adjusted by folding segment of material 1 and securing its stance with Velcro or other fasteners. Boiling point of liquid 2 changes according to pressure and can be tuned to desired setpoint value 9.

When temperature of material 1 drops below value 9, vapors 4 condense to liquid 2 and material 1 seizes to transfer heat. Gas 5 creates heat insulating cushion that turns material 1 into thermal insulator.

Upon achievement of temperature 9, vapors 4 are formed that began to transport heat along the volume 3 throughout the bulk of material 1. Material 1 behaves as heat pipe device providing excellent heat transfer characteristics between any locations. All locations of material 1 assume the same temperature. Supply of heat at any location causes evaporation of liquid 2 and formation of vapors 4. Increase in partial pressure of vapors 4 distributes across volume 3 and causes condensation of vapor 4 and formation of liquid 2 at locations that absorb heat.

Because specific surface area of material 1 is high it efficiently transfers heat to any adjacent media gaseous, liquid, or solid. This makes excellent heat sink. Conventional heat sinks have significant thermal gradients across their structures, which causes inefficient use of notable portion of their surface area. Material 1 remains isothermal that provides equal heat transfer to ambient media from any location of its surface.

Material 1 may be utilized at broad range of applications. In addition to thermal management it provides excellent shock absorption/cushioning. This absorption is caused in part by pressurized vapors 4 and gases 5, and in part by liquid 2. Deformation of material 1 transfers energy of deformation into kinetic motion of liquid 2 and gases 5 and vapors 4. This causes redirection and adsorption of deformation energy into heat form through the volume 3.

As represented by preferred embodiment, material 1 is composed of thermoplastic materials. This makes possible custom cutting and shaping without any special equipment. Application of pressure and brief heating to melting point of thermoplastic causes formation of seam 1 0 that seals volume 2. Any cutting tool can be used to cut material 1 along seam 1 0 without exposing volume 2 and affecting its thermal operations.

Methods of manufacturing of material 1 were described in co-pending application Ser. Nos. 11/307359, 11/307292, 11/307051. Trivial adjustments to the processes include addition of gas 5. Other methods of manufacturing may be employed to produce material 1. It is obvious to one experience in art of textile and polymer films how to adapt existing technologies to produce material of this invention.

What is claimed is:

1. A textile that comprises single interconnected volume embedded within, and phase changing liquid composition, wherein said volume is sealed from ambient environment by means of substance that is impermeable to vapors of said liquid composition, and said liquid and associated vapors are disposed within said volume.

2. A textile of claim 1, wherein said volume also contains gaseous chemicals that do not undergo phase transitions at usable temperature range of the textile.

3. An article utilizing textile of claim 2 wherein there is an element capable of changing partial pressure of said chemicals within said volume.

4. An article of claim 3, wherein said element can be tuned by user of the article.

5. A textile of claim 1 wherein said substance and all structural content of said volume are thermoplastic materials.

6. A textile of claim 2 wherein said substance and all structural content of said volume are thermoplastic materials.

7. An article of textile of claim 1 that redirects and absorbs energy of mechanical deformation into heat of said liquid.

8. An article of textile of claim 2 that redirects and absorbs energy of mechanical deformation into heat of said liquid.

9. A textile that comprises plurality of segments wherein some of said segments are textile of claim 1.

10. A textile that comprises plurality of segments wherein some of said segments are textile of claim 2.
